(19) United States
(12) Patent Application Publication
(10) Pub. No.: US 2026/0063416 A1
(43) Pub. Date: Mar. 5, 2026

(54) FIBER SHAPE MEASUREMENT METHOD AND APPARATUS

(71) Applicant: Huawei Technologies Co., Ltd., Shenzhen (CN)

(72) Inventors: Zhiping Jiang, Kanata (CA); Pedro Tovar Braga, Ottawa (CA); Jiachuan Lin, Stittsville (CA)

(21) Appl. No.: 19/009,773

(22) Filed: Jan. 3, 2025

Related U.S. Application Data
(60) Provisional application No. 63/689,144, filed on Aug. 30, 2024.

(51) Int. Cl. G01B 11/24; G01D 5/353; G01H 9/00

(52) U.S. Cl. CPC G01B 11/24; G01D 5/35361; G01H 9/004

(57) ABSTRACT

The present disclosure provides a fiber shape measurement method. The fiber shape measurement method may measure shapes of multiple optical fibers without limiting types of optical fibers, improving a flexibility and applicability. The method includes: determining, based on a correlation between measured acoustic vibration signals at segments in each pair of fiber segments in a plurality of fiber segments of an optical fiber, a spatial distance between each pair of fiber segments; determining a fiber distance between each pair of fiber segments of the plurality of fiber segments, where the fiber distance represents a path length along the optical fiber; and determining a shape of the optical fiber based on spatial distances and fiber distances of pairs of fiber segments in the plurality of fiber segments.

### CROSS REFERENCE TO RELATED APPLICATION

This application claims priority to U.S. Provisional Application No. 63/689,144, filed Aug. 30, 2024, the disclosure of which is incorporated herein by reference in its entirety.

### TECHNICAL FIELD

The present disclosure generally relates to the field of communication, and in particular to a fiber shape measurement method and a fiber shape measurement apparatus.

### BACKGROUND

Fiber shape sensing (FSS) is a technique allowing the measurement of the fiber shape by shining a light source into a fiber and capturing/processing the reflected light. In fiber shape sensors, fiber that bends in any spatial direction (x, y, z) may be identified. The identification of a fiber curvature in a particular direction is enabled by the usage of either multi-core fibers, where diametrically opposed cores experience differing strain (contraction/expansion), or multiple single-core fibers, which follow the same principle but have a larger separation between cores. FSS using multi-core fibers finds application in medical procedures (e.g. “multi-core optical fibers with Bragg gratings as shape sensor for flexible medical instruments”).

Most of the telecom cables are composed of single-core single-mode fibers (SC-SMFs), and the relative position of multiple single-core fibers is not fixed over long distances. So, it may not be possible to accurately detect the shapes of multiple single-core fibers purely through differing strain (contraction/expansion). In other words, the unpredictable twisting of fibers within a multi-fiber cable makes the usage of FSS using multiple single-core fibers unfeasible in practical applications. FSS finds no applications in the telecom industry.

The current FSS methods may be applicable to multi-core fibers, but may not be applicable to single-core fibers because they may not measure a shape of a single-core fiber.

### SUMMARY

Implementations of the present disclosure provide a fiber shape measurement method and apparatus, which may measure shapes of optical fibers without limiting types of optical fibers, improving flexibility and applicability.

In a first aspect, a fiber shape measurement method is described. The method may be applied to a fiber shape measurement apparatus, or a component in the fiber shape measurement apparatus (e.g. a module, a circuit, or a chip in the storage device). The method includes: determining, based on a correlation between measured acoustic vibration signals at segments in each pair of fiber segments in a plurality of fiber segments of an optical fiber, a spatial distance between each pair of fiber segments; determining a fiber distance between each pair of fiber segments of the plurality of fiber segments, where the fiber distance represents a path length along the optical fiber; and determining a shape of the optical fiber based on spatial distances and fiber distances of pairs of fiber segments in the plurality of fiber segments.

The above optical fiber may be understood as an optical fiber to be measured, which may include a plurality of fiber segments. In embodiments of the present disclosure, the fiber to be measured may be referred to as a fiber under test (FUT), the fiber segment may also be referred to as an optical fiber segment, and these are not limited thereto. The FUT may include a plurality of optical fiber segments (e.g. fiber segment A, fiber segment B, fiber segment C, etc.). The plurality of fiber segments may be obtained by uniformly dividing the optical fiber; or may be obtained by non-uniformly dividing the optical fiber, and this is not limited thereto. In a possible implementation, the fiber shape measurement apparatus may divide an optical fiber to be measured to obtain a plurality of optical fiber segments. It is understood that division of the optical fiber into the fiber segments and selection of the situation may depend on the specific application scenario, and this is not limited thereto.

In this case, the fiber shape measurement apparatus may determine a shape of the optical fiber by the spatial distances and the fiber distances of pairs of optical fiber segments in the plurality of optical fiber segments. By using the spatial distances and the fiber distances instead of detecting strain (contraction/expansion) in a number of cores in a multi-core fiber to measure the shape of fibers, the method may also be applicable in SC-SMF and multi-core fibers. So, the fiber shape measurement method may be applied to single-core fibers or multi-core fibers without limiting types of fibers, thus improving a flexibility and applicability.

In some embodiments, the fiber shape measurement method may further include: obtaining the acoustic vibration signals by using a distributed acoustic sensing (DAS) system; calculating a similarity between the acoustic vibration signals at the segments in the pair of fiber segments, the similarity representing the correlation between the acoustic vibration signals at the segments in the pair of fiber segments; and determining the spatial distances based on similarities between acoustic vibration signals of segments in the pairs of fiber segments.

In some embodiments, the spatial distance is inversely proportional to the similarity.

If two fiber segments have a small spatial distance therebetween, it may indicate that ambient noise around the two fiber segments may be similar and acoustic vibration signals measured at the two fiber segments may be similar. That is, the similarity between the acoustic vibration signals of the two fiber segments may be high. For example, Pearson correlation coefficient of the two acoustic vibration signals measured at the two fiber segments may be close to 1. Likewise, if two fiber segments have a large spatial distance therebetween, it may indicate that ambient noise around the two fiber segments may be different and acoustic vibration signals measured at the two fiber segments may be different. That is, the similarity between the acoustic vibration signals of the two fiber segments may be small. For example, the Pearson correlation coefficient of the two acoustic vibration signals measured at the two fiber segments may be close to 0.

In some embodiments, determining the fiber distance may include: determining the fiber distance based on a speed at which an optical signal propagates in the optical fiber, and a measured propagation time of the optical signal between segments in the pair of fiber segments.

In some embodiments, determining the shape of the optical fiber may include: determining a first acoustic correlation map based on the spatial distances and the fiber distances, where the first acoustic correlation map displays a relationship between the spatial distances and the fiber distances; and determining the shape of the optical fiber based on the first acoustic correlation map.

In some embodiments, determining the shape of the optical fiber may include: determining a plurality of shapes of optical fibers and a plurality of corresponding acoustic correlation maps by simulation; selecting a second acoustic correlation map from the plurality of the acoustic correlation maps simulated which is most similar to the first acoustic correlation map; and determining the shape of the optical fiber as a shape of an optical fiber of the second acoustic correlation map.

The fiber shape measurement apparatus may obtain, by simulation, a large database including a plurality of acoustic correlation maps corresponding to different fiber shapes. In a case where a first acoustic correlation map is obtained experimentally, a second acoustic correlation map which may be most similar to the first acoustic correlation map may be obtained from the above database and the fiber shape may be determined as the fiber shape of the second acoustic correlation map.

In this way, the fiber shape measurement apparatus may quickly find the most matching optical fiber shape in the database, which may be conducive to improving the efficiency of fiber shape measurement.

In some embodiments, determining the shape of the optical fiber may include: obtaining the shape of the optical fiber by a trained neural network using the first acoustic correlation map, where the neural network is obtained by training sample data.

By combining with the neural network technology, the method may further improve the speed and accuracy of the fiber shape measurement. In addition, the fiber shape measurement based on the neural network model may automatically learn shape features and make judgments in a data-driven manner. This may not only reduce a need for human intervention, but also reduce human error and improve an automation of the measurement process.

In a second aspect, an apparatus for an optical fiber shape measurement is described, which includes a processor and an interface circuit, where the processor is connected to the interface circuit, and the processor is configured to: determine, based on a correlation between measured acoustic vibration signals at segments in each pair of fiber segments in a plurality of fiber segments of an optical fiber, a spatial distance between each pair of fiber segments; determine a fiber distance between each pair of fiber segments of the plurality of fiber segments, where the fiber distance represents a path length along the optical fiber; and determine a shape of the optical fiber based on spatial distances and fiber distances of pairs of fiber segments in the plurality of fiber segments.

In some embodiments, the processor is further configured to: obtain the acoustic vibration signals by using a distributed acoustic sensing (DAS) system; calculate a similarity between the acoustic vibration signals at the segments in the pair of fiber segments, the similarity representing the correlation between the acoustic vibration signals at the segments in the pair of fiber segments; and determine the spatial distances based on similarities between acoustic vibration signals of segments in the pairs of fiber segments.

In some embodiments, the spatial distance is inversely proportional to the similarity.

In some embodiments, the processor is further configured to: determine the fiber distance based on a speed at which an optical signal propagates in the optical fiber, and a measured propagation time of the optical signal between segments in the pair of fiber segments.

In some embodiments, the processor is further configured to: determine a first acoustic correlation map based on the spatial distances and the fiber distances, where the first acoustic correlation map displays a relationship between the spatial distances and the fiber distances; and determine the shape of the optical fiber based on the first acoustic correlation map.

In some embodiments, the processor is further configured to: determine a plurality of shapes of optical fibers and a plurality of corresponding acoustic correlation maps by simulation; select a second acoustic correlation map from the plurality of the acoustic correlation maps simulated which is most similar to the first acoustic correlation map; and determine the shape of the optical fiber as a shape of an optical fiber of the second acoustic correlation map.

In some embodiments, the processor is further configured to: obtain the shape of the optical fiber by a trained neural network using the first acoustic correlation map, where the neural network is obtained by training sample data.

In a third aspect, a computer-readable storage medium is described, which has instructions stored thereon which, when executed by one or more processors, cause the one or more processors to perform the method in any possible implementation of the first aspect.

This disclosure encompasses various embodiments, including not only method embodiments, but also other embodiments such as apparatus embodiments and embodiments related to non-transitory computer readable storage media. Embodiments may incorporate, individually or in combinations, the features disclosed herein.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a schematic diagram of a distributed acoustic sensing (DAS) system based on Rayleigh scattering in accordance with some embodiments of the present disclosure;

FIG. 2 is a schematic diagram of a waterfall plot corresponding to a sensing result of a DAS system in accordance with some embodiments of the present disclosure;

FIG. 3 is a schematic diagram of a co-trench detection system in accordance with some embodiments of the present disclosure;

FIG. 4 is a schematic diagram of a fiber-optic link between two terminals with a number of manholes where fiber slacks may be present in accordance with some embodiments of the present disclosure;

FIG. 5 is a flow chart of a fiber shape measurement method, in accordance with some embodiments of the present disclosure;

FIG. 6 is a schematic diagram of a spatial distance detection system in accordance with some embodiments of the present disclosure;

FIG. 7 is a schematic diagram of an example fiber shape, in accordance with some embodiments of the present disclosure;

FIG. 8 is a schematic diagram of an example of fiber shape and its corresponding correlation map in accordance with some embodiments of the present disclosure;

FIG. 9 is a schematic diagram of another example of fiber shape and its corresponding correlation map in accordance with some embodiments of the present disclosure;

FIG. 10 is a schematic diagram of another example of fiber shape and its corresponding correlation map in accordance with some embodiments of the present disclosure;

FIG. 11 is a schematic diagram of another example of fiber shape and its corresponding correlation map in accordance with some embodiments of the present disclosure;

FIG. 12 is a schematic diagram of a processor of a fiber shape measurement apparatus and its interface circuit in accordance with some embodiments of the present disclosure;

FIG. 13 is a schematic diagram of a processing unit and its primary supportive components/systems of an example fiber shape measurement apparatus in accordance with some embodiments of the present disclosure; and

FIG. 14 is a schematic diagram of a processing unit and its primary supportive components/systems of another example fiber shape measurement apparatus in accordance with some embodiments of the present disclosure.

### DETAILED DESCRIPTION

Embodiments of the present disclosure are described below with reference to the accompanying drawings.

Optical fibers, also referred to as fibers, optical fiber link, fiber link, etc., as important communication media and sensor elements, may be widely used in communication, sensing, medical and industrial fields. By monitoring the shape of optical fibers on a regular basis or in real time, the location of fiber slacks, either in manholes or aerial fiber slacks, may help to identify the geographical location of potential faults, reducing the time to take necessary maintenance measures, thus ensuring normal operation of a communication system and reducing risk of faults.

Current fiber shape sensing (FSS) technology may have good applications in shape measurement of multi-core optical fibers. In a multi-core optical fiber, relative position between different cores may be fixed. In a case where external stress changes, different cores may produce different strains (contraction/expansion.). Then, based on the relative positions of the different cores, a shape of the multi-core fiber may be measured.

However, because most of the telecom cables may be composed of single-core single-mode fibers (SC-SMF), FSS may not find many applications in the telecom industry. Multiple single-core fibers may be present in a telecom cable, and relative positions of multiple single-core fibers may not be fixed over long distances, so it is not possible to accurately measure shapes of single-core fibers from external stresses. Therefore, FSS may not be used in the telecom industry.

For ease of understanding, the technical terms involved in the embodiments are first described below.

### 1. Fiber Shape Sensing (FSS)

Fiber shape sensing (FSS) technology is a technique allowing the measurement of the fiber shape by shining a light source into a fiber and capturing/processing the reflected light, which may have good applications in shape measurement of multi-core optical fibers. This technology may be widely used in many fields such as engineering, aerospace, medical, construction, robotics, etc. Examples can be seen in “Multi-Core Optical Fibers With Bragg Gratings as Shape Sensor for Flexible Medical Instruments” Fouzia Khan; et al. (2019).

For example, FSS technology may rely on strain and curvature sensing properties of multi-core optical fibers, and monitors deformation (e.g. bending, stretching or compression) of multi-core optical fibers by transmitting optical signals in the multi-core optical fibers.

### 2. Distributed Acoustic Sensing (DAS)

Distributed acoustic sensing (DAS) is a fiber-based technique to measure acoustic vibrations along an optical fiber. Many techniques may be used to achieve DAS, and the most common technique is based on Rayleigh scattering, but Brillouin scattering and Raman scattering may also be used. Examples can be seen in “Pushing the Reach of Fiber Distributed Acoustic Sensing to 125 km Without the Use of Amplification” Gregor Cedilnik; et al. (2018); and U.S. Pat. No. 5,194,847 to Henry F. Taylor et al.; each of which is expressly incorporated by reference herein. A common Rayleigh scattering based technique used to analyze a fiber's integrity is optical time domain reflectometry (OTDR). OTDR may be a common technology for fiber break detection. In OTDR technology, characteristics of an optical fiber may be analyzed by transmitting optical pulses along the optical fiber and then detecting reflected signals (i.e., echoes) of the optical pulses. OTDR technology is mainly used for detecting information such as distributed fiber loss and points of failure of an optical fiber. Phase-sensitive optical time domain reflectometry (Φ-OTDR) technology is an important extension of OTDR technology, combining principles of traditional OTDR and phase-sensitive detection, enabling high-resolution measurements, especially in applications such as dynamic monitoring of optical fibers, vibration detection and strain monitoring.

FIG. 1 shows a basic setup of a typical DAS system based on Rayleigh scattering, which is referred to as phase-sensitive optical time domain reflectometer (Φ-OTDR). Other DAS systems may be used to measure acoustic vibration signals at fiber segments in a plurality of fiber segments. As shown in FIG. 1, optical pulses are prepared from an electrical arbitrary waveform generator (AWG), which drives an acousto-optic modulator (AOM). Pulses are amplified in an erbium-doped fiber amplifier (EDFA) and launched into a fiber under test (FUT) through an optical circulator (OC). Coherent detection is performed with a balanced photo detector (BPD) and analog to digital conversion is employed in a data acquisition (DAQ) system.

An optical pulse from a laser source with narrow linewidth is launched into a standard single-mode fiber (SMF), and inhomogeneities of the fiber's refractive index (sometimes described as impurities along the fiber) end up scattering the pulse in all directions. Part of the scattered light propagates in the backward direction and is captured at the pulse launching end. Analogous to radar technology, the arrival time of the backscattered light gives the location information. Acoustic vibrations along the fiber affect both the intensity and the phase of the backscattering signal, such that DAS technology offers acoustic information at multiple (distributed) points along the fiber. In simple terms, it is equivalent to have an array of microphones capturing acoustic vibrations over long distances, which may extend over tens of kilometers. Further, according to the acoustic information at multiple points along the fiber, multiple acoustic vibration signals may be obtained.

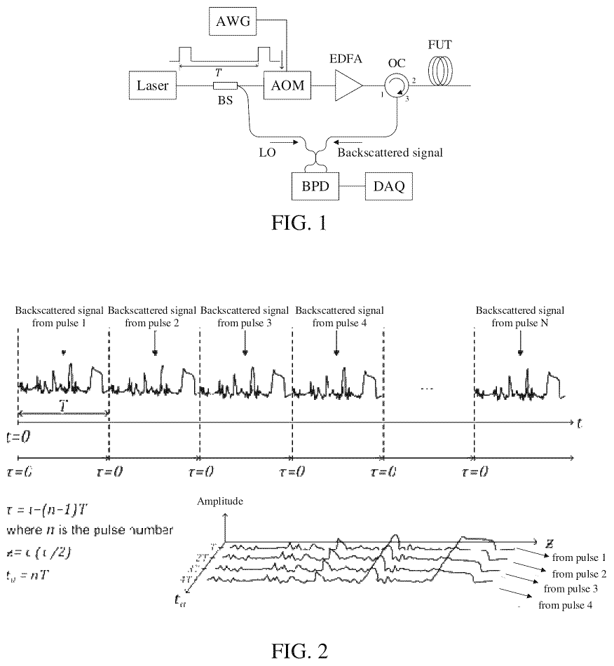

When DAS systems are used, their sensing result may produce a three-dimensional graph that is commonly referred to as a waterfall plot. One of its axes corresponds to fiber-distance, indicating the location at which an acoustic vibration occurred, the second axis is related to the evolution of vibrations in time, and the third axis informs the vibration's amplitude, as shown in FIG. 2. The conversion from the continuous backscattered signal captured at the DAQ to the waterfall plot is performed as follows. First, the continuous measurement time t (which may begin when the first pulse enters the fiber) is converted into fiber distance [symbol] by:

$$𝔷 = c τ / 2. \qquad ( 1 )$$

Where t corresponds to the time it takes for light to reach location [symbol] and to return from it, which is the reason for the factor τ/2. For the calculation of [symbol] it only matters the time starting from the moment when a new pulse enters the fiber. Considering that a time difference between the first pulse and the moment when the new pulse enters the fiber is a time difference between a total measurement time t (i.e., the continuous measurement time) and (n−1)T, τ may be written as:

$$τ = t - ( n - 1 ) T . \qquad ( 2 )$$

where n is the number of pulses launched since the first pulse and T is the pulse period.

From the definitions above, the vibration at every location [symbol] may be sampled every T, so that the temporal evolution for the purpose of acoustic sensing, i.e., the acoustic time for the measurement of acoustic vibrations tₐ may be considered, and tₐ may be written as:

$${t}_{a} = n T . \qquad ( 3 )$$

For example, for a given fiber segment, that segment is always sampled with a period T, so that tₐ reflects the passage of the absolute time ‘t’ but sampled every T. Note that, even though the vibrations at different locations may occur at different times within T, since the speed of sound is much smaller than the speed of light, it is assumed that every optical pulse takes a screenshot of the fiber's vibrational state at time tₐ. In such a way, the waterfall plot is constructed based on the three elements: vibration amplitude, fiber-distance [symbol] , and acoustic time tₐ. Therefore, the acoustic vibration signal at an arbitrary fiber-distance [symbol] ᵢ may be expressed by s( [symbol] ᵢ, tₐ).

### 3. Co-Trench Detection

It is of great interest to know if two optical cables are following the same physical path or if they have separate routes. The importance relies on having a fully redundant optical network, such that even the physical layer (optical fiber) has a backup—a physical problem in the main fiber will not affect the reserve fiber if they are spatially apart. This concept is referred to as “co-trench detection”, where two fibers are said to be in co-trench in case they follow the same route. Examples can be seen in “Highly Sensitive Co-trench Detection of Optical Fibers by Correlation Analysis with Field Test” Jia chuan Lin; et al. (2024), which is expressly incorporated by reference herein.

DAS systems have been used before for co-trench detection. The key principle is to make use of random acoustic vibrations present in the environment: acoustic noise measured from two different DAS systems (DAS₁ and DAS₂) in two different fibers will have similar acoustic signature if the fibers are in co-trench condition. Therefore, co-trench detection is realized through the calculation of a cross-correlation matrix C, elements of which are defined by:

$${c}_{i , j} = corr ( {s}_{fiber 1} ( {𝔷}_{i} , {t}_{a} ) , {s}_{fiber 2} ( {𝔷}_{j} , {t}_{a} ) ) . \qquad ( 4 )$$

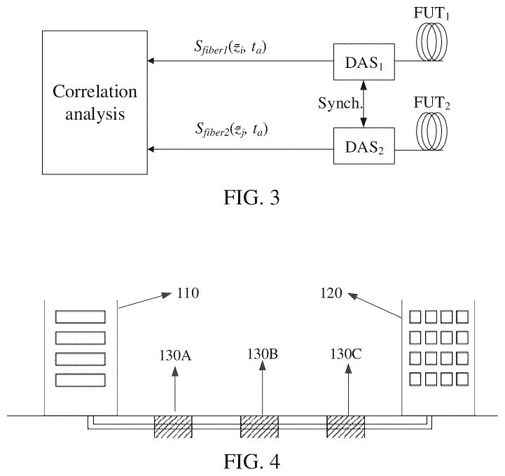

In Eq. (4), s_{fiber1}( [symbol] ᵢ, tₐ) represents an acoustic vibration signal measured from DAS, connected to the first fiber at location [symbol] ᵢ, and s_{fiber2}( [symbol] ⱼ, tₐ) is another acoustic vibration signal measured from DAS₂ connected to a second fiber at location [symbol] ⱼ. FIG. 3 shows an experimental setup of a typical co-trench detection system using DAS.

### 4. Aerial Slack

Aerial slack may refer to a phenomenon in which optical fibers erected in the air are slack due to excessive fiber lengths being reserved for installation, or due to weather, wind, temperature changes, etc. This slack optical fiber may oscillate, fray or be physically damaged in windy environments

### 5. Manhole Slack

Manhole slack may refer to an excess length of an optical fiber in a laying process, which is present in an underground space designed for manual access/maintenance. Slack optical fiber may appear local bending, elongation or excessive bending, affecting quality of signal transmission.

Detecting fiber slack in manholes may help to assess an amount of fiber available in the manholes for maintenance purposes, and help to geo-locate fiber break points. FIG. 4 shows an example of optical fiber link with 3 manholes (i.e. manholes 130A, 130B and 130C). Besides the 3 manholes (i.e. manholes 130A, 130B and 130C), FIG. 4 also shows an optical link terminal 110 and a building 120, and the optical link terminal 110 and the building 120 are connected via the optical fiber link with the 3 manholes to enable transmission of signals.

In order to detect fiber slacks, shapes of the fibers may be measured. In current FSS technology, it may not be available to measure shapes of single-core fibers, and therefore fiber slacks may not be detected. For example, the fiber link breaks between manhole 130A and manhole 130B. OTDR may not be able to inform the location where the break occurred, and it may only provide information of the fiber distance from the optical line terminal 110 to the break point. In case a long fiber slack is present in manhole 130A, an OTDR result may give the impression that the break point is further away from manhole 130B, not in between manholes 130A and 130B.

Currently, there may not be available techniques for detecting fiber slacks, either for manhole slacks or aerial slacks. Therefore, how to measure shapes of multiple optical fibers without limiting types of fibers is an urgent problem.

In view of this, some embodiments of the present disclosure provide a fiber shape measurement method. In this method, by measuring acoustic vibration signals of each fiber segment in each pair of fiber segments in a plurality of fiber segments of an optical fiber, a correlation between the acoustic vibration signals of the fiber segments included in each pair of fiber segments is obtained to determine a spatial distance between the fiber segments included in each pair of fiber segments. And a fiber distance between the fiber segments included in each pair of fiber segments is determined through measurements. By combining spatial distances and fiber distances, a shape of this optical fiber may finally be measured, which may measure shapes of multiple optical fibers without limiting types of optical fibers, improving a flexibility and applicability.

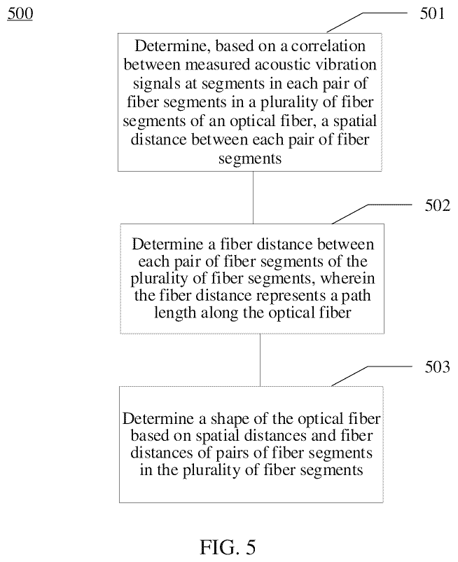

The fiber shape measurement method according to some embodiments of the present disclosure will be described in detail below in conjunction with FIGS. 5 to 9.

For ease of understanding, embodiments of the present disclosure are described by taking an example in which the fiber shape measurement method is performed at a fiber shape measurement apparatus.

FIG. 5 is a flow chart of a fiber shape measurement method 500, in accordance with some embodiments of the present disclosure. The method 500 may be applied to the manhole slack scenario shown in FIG. 4, but also to other scenarios where a shape of a fiber is to be measured, and this is not limited thereto. The fiber shape measurement method 500 may include steps 501 to 503.

In step 501, the fiber shape measurement apparatus may determine, based on a correlation between measured acoustic vibration signals at segments in each pair of fiber segments in a plurality of fiber segments of an optical fiber, a spatial distance between each pair of fiber segments.

The optical fiber may be understood as an optical fiber to be measured, which may include a plurality of fiber segments. The optical fiber to be measured may be referred to as a fiber under test (FUT), the fiber segment may also be referred to as an optical fiber segment, and these are not limited thereto. The FUT may include a plurality of optical fiber segments (e.g. fiber segment A, fiber segment B, fiber segment C, etc.). The plurality of fiber segments may be obtained by uniformly dividing the optical fiber; or may be obtained by non-uniformly dividing the optical fiber, and this is not limited thereto. In a possible implementation, the fiber shape measurement apparatus may divide an optical fiber to be measured to obtain a plurality of optical fiber segments. It is understood that division of the optical fiber is merely theoretical, not practical, and division of the optical fiber into the fiber segments and selection of the situation may depend on the specific application scenario, and this is not limited thereto.

A plurality of pairs of fiber segments may be obtained based on the plurality of optical fiber segments. Among the plurality of fiber segments, any two fiber segments may be used as a pair of fiber segments. Every pair of fiber segments from the plurality of pairs of fiber segments is selected to calculate the spatial distance between segments in each pair of fiber segments.

For example, the fiber shape measurement apparatus may uniformly divide an optical fiber into 4 fiber segments including: fiber segment A, fiber segment B, fiber segment C and fiber segment D. In this case, 6 pairs of fiber segments may be obtained based on the 4 fiber segments, where the fiber segment A constitutes a pair of fiber segments with the fiber segment B. The fiber segment A constitutes a pair of fiber segments with the fiber segment C. The fiber segment A constitutes a pair of fiber segments with the fiber segment D. The fiber segment B constitutes a pair of fiber segments with the fiber segment C. The fiber segment B constitutes a pair of fiber segments with the fiber segment D. The fiber segment C constitutes a pair of fiber segments with the fiber segment D.

In the above example, any two fiber segments may be used as a pair of fiber segments. A specific division of the optical fiber into the fiber segments may depend on the specific application scenario, and this is not limited thereto.

In this step 501, the fiber shape measurement apparatus may first measure an acoustic vibration signal of each fiber segment in each pair of fiber segments, and then calculate correlations between acoustic vibration signals of fiber segments included in each pair of fiber segments to obtain a plurality of correlations whose number is equal to the number of pairs of fiber segments. The optical fiber shape measurement apparatus may determine, based on each of the plurality of correlations, a spatial distance between fiber segments included in a corresponding one of the pairs of fiber segments, obtaining a plurality of spatial distances whose number is equal to the number of the pairs of fiber segments.

In step 502, the fiber shape measurement apparatus may determine a fiber distance between each pair of fiber segments of the plurality of fiber segments, where the fiber distance represents a path length along the optical fiber.

The fiber shape measurement apparatus may obtain the fiber distance between each pair of fiber segments by measurement, and the fiber distance refers to a length of the path along the optical fiber between two fiber segments included in the pair of fiber segments.

For ease of description, a pair of fiber segments including fiber segment A and fiber segment B may be taken as an example to illustrate how a fiber distance between the fiber segment A and the fiber segment B is obtained.

In a possible implementation, the fiber distance may refer to a fiber distance between any point on the fiber segment A and any point on the fiber segment B. For example, the fiber distance may be a distance between a starting point of the fiber segment A and a starting point of the fiber segment B. For another example, the fiber distance may be a fiber distance between an ending point of the fiber segment A and an ending point of the fiber segment B. For yet another example, the fiber distance may also be a fiber distance between a midpoint of the fiber segment A and a midpoint of the fiber segment B. The choice of fiber segment point to define fiber distance, however, should be consistent for all fiber segments. For example, if the midpoint alternative is chosen for the fiber segment A, then it should be chosen for all other fiber segments.

It is understood that the starting point of the fiber segment A may refer to any one of two endpoints of the fiber segment A, the ending point of the fiber segment A may refer to the other of the two endpoints of the fiber segment A, and the midpoint of the fiber segment A may refer to a center point between the two endpoints of the fiber segment A. Likewise, the starting point of the fiber segment B may refer to any one of two endpoints of the fiber segment B, the ending point of the fiber segment B may refer to the other of the two endpoints of the fiber segment B, and the midpoint of the fiber segment B may refer to a center point between the two endpoints of the fiber segment B.

In another possible implementation, the fiber distance may refer to a difference between a fiber distance between any point on the fiber segment A and a launching point of the optical fiber, and a fiber distance between any point on the fiber segment B and the launching point of the optical fiber. For example, the fiber distance may be a difference between a fiber distance between the starting point of the fiber segment A and the launching point of the optical fiber, and a fiber distance between the starting point of the fiber segment B and the launching point of the optical fiber. For another example, the fiber distance may be a difference between a fiber distance between the ending point of the fiber segment A and the launching point of the optical fiber, and a fiber distance between the ending point of the fiber segment B and the launching point of the optical fiber. For yet another example, the fiber distance may be a difference between a fiber distance between the midpoint of the fiber segment A and the launching point of the optical fiber, and a fiber distance between the midpoint of the fiber segment B and the launching point of the optical fiber.

It is understood that the launching point of the optical fiber may be any one of two endpoints of the optical fiber, or a point on the optical fiber selected by the fiber shape measurement apparatus, and the launching point of the optical fiber is not limited thereto.

In step 503, the fiber shape measurement apparatus may determine a shape of the optical fiber based on spatial distances and fiber distances of pairs of fiber segments in the plurality of fiber segments.

By the steps 501 and 502, the fiber shape measurement apparatus may obtain a spatial distance and a fiber distance of each pair of fiber segments in the plurality of fiber segments. Further, the fiber shape measurement apparatus may determine a shape of the optical fiber in a variety of ways. In general, there may be a small spatial distance but a large fiber distance between a pair of fiber segments, which may indicate that there may be loops or bends between the pair of fiber segments. And the loops or bends may be determined by, for example, matching simulated data on the spatial distance and the fiber distance measured, or by combining trained neural network models based on a plurality of spatial distances and fiber distances.

In a possible implementation, the fiber shape measurement apparatus may determine the shape of the optical fiber by itself based on the data obtained by the steps 501 and 502. In another possible implementation, the fiber shape measurement apparatus may transmit the data obtained by steps 501 and 502 to other devices (e.g. a data analysis device or a cloud server), which may process and analyze the data to get the shape measurement result of the optical fiber, and returning the measurement result to the fiber shape measurement apparatus.

In the fiber shape measurement method described above, the fiber shape measurement apparatus may determine a shape of the optical fiber according to the spatial distance and the fiber distance of each pair of optical fiber segments in the plurality of optical fiber segments. By using spatial distances and fiber distances instead of detecting strain (contraction/expansion) of fibers to measure shapes of fibers, even if using a cable bundle of single-core fibers in which relative positions of multiple single-core fibers are not fixed over long distances, the method may also be applicable. The method may also be applicable to a cable with only one single-core fiber, and application scenarios of this method are not limited thereto.

The fiber shape measurement method may be applied to single-core fibers or multi-core fibers without limiting types of fibers, thus improving a flexibility and applicability.

In addition, the fiber shape measurement method of embodiments of the present disclosure may be used for optical fiber slack (e.g. manhole slack and aerial slack) detection, to measure a location and a length of a fiber slack in an optical fiber link, and thus to prevent fraud in optical fiber links installation. In a possible application scenario, the fiber shape measurement method may be used to detect a fiber slack in a single-core fiber in a telecommunication cable, thereby facilitating maintenance and improving the performance of a communication system.

A process in which the fiber shape measurement apparatus may determine a spatial distance between each pair of fiber segments is described in detail below.

In some embodiments, the step 501 may include: obtaining the acoustic vibration signals by using a distributed acoustic sensing (DAS) system; and calculating a similarity between the acoustic vibration signals at the segments in the pair of fiber segments, the similarity representing the correlation between the acoustic vibration signals at the segments in the pair of fiber segments; and determining the spatial distances based on similarities between acoustic vibration signals of segments in the pairs of fiber segments.

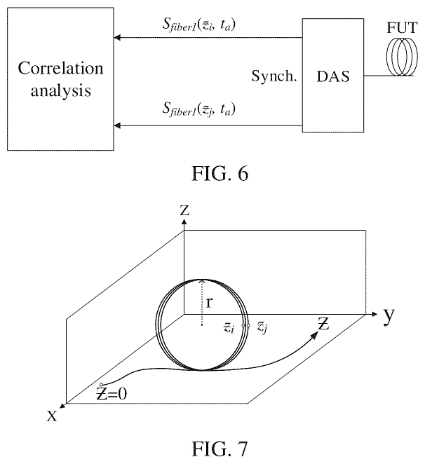

Unlike the typical co-trench detection system shown in FIG. 3, embodiments of the present disclosure may use one DAS system to measure spatial distances between different locations in a FUT to obtain the specific shape of the FUT. The detection system of the present disclosure is shown in FIG. 6. There is one DAS system that measures acoustic vibration signals from locations [symbol] ᵢ and [symbol] ⱼ on the FUT. According to correlation analysis, correlation of acoustic noise between different locations on the FUT may be calculated based on the acoustic vibration signals. Further, spatial distances between these locations may be obtained based on the correlation of acoustic noise.

In the DAS system shown in FIG. 6, s_{fiber1}( [symbol] ᵢ, tₐ) may represent an acoustic vibration signal measured by the DAS system on a fiber segment of the FUT at a position of [symbol] ᵢ. Similarly, s_{fiber1}( [symbol] ⱼ, tₐ) may represent an acoustic vibration signal measured by the DAS system on another fiber segment of the FUT at a position of [symbol] ⱼ.

In a possible implementation, [symbol] ᵢ may refer to a position of any point on any fiber segment, and [symbol] ⱼ may refer to a position of any point on any fiber segment other than the fiber segment where [symbol] ᵢ is located. However, the choice of points in fiber segments may be consistent for all segments as mentioned before. In another possible implementation, [symbol] ᵢ may refer to a position of the launching point of the optical fiber and [symbol] ⱼ may refer to a position of any point on any fiber segment.

Based on the acoustic vibration signals, the fiber shape measurement apparatus may calculate a similarity between the acoustic vibration signals of the pair of fiber segments, the similarity representing a correlation between the acoustic vibration signals of the pair of fiber segments. In a possible implementation, the similarity between the acoustic vibration signals may be represented by a Pearson correlation coefficient a_{i,j}, where i and j correspond to the segments [symbol] ᵢ and [symbol] ⱼ. The Pearson correlation coefficient is a statistical measure of a strength and direction of a linear relationship between two variables. Based on the similarity between the acoustic vibration signals of the different fiber segments in the pair of fiber segments, the fiber shape measurement apparatus may determine a spatial distance between the different fiber segments in the pair of fiber segments. For example, the fiber shape measurement apparatus may obtain a quantitative correspondence between the similarity and the spatial distance based on multiple measurements, and then the spatial distance may be determined based on a corresponding similarity and the quantitative correspondence.

In some examples, the spatial distance is inversely proportional to the similarity.

If two fiber segments have a small spatial distance therebetween, it may indicate that ambient noise around the two fiber segments may be similar and acoustic vibration signals of the two fiber segments may be similar. That is, the similarity between the acoustic vibration signals of the two fiber segments may be large. For example, Pearson correlation coefficient of the two fiber segments may be close to 1. Likewise, if two fiber segments have a large spatial distance therebetween, it may indicate that ambient noise around the two fiber segments may be different and acoustic vibration signals of the two fiber segments may be different. That is, the similarity between the acoustic vibration signals of the two fiber segments may be small. For example, the Pearson correlation coefficient of the two fiber segments may be close to 0.

Embodiments of the present disclosure may rely in correlating one DAS acoustic signal with itself. The interest is in the auto-correlation matrix A. For all pairs of fiber segments in the FUT, Pearson correlation coefficient a_{i,j} is calculated, and the auto-correlation matrix A is determined as detailed next.

For example, a FUT of length L is uniformly divided into N segments, and for two arbitrary segments located at positions [symbol] ᵢ and [symbol] ⱼ, where i∈[1, N], j∈[1, N], [symbol] ᵢ∈[0, L], [symbol] ⱼ∈[0, L], i and j are positive integers, the acoustic waveform is obtained, i.e. s_{fiber1}( [symbol] ᵢ, tₐ) and s_{fiber1}( [symbol] ⱼ, tₐ). The elements of the auto-correlation matrix A may be derived from:

$${a}_{i , j} = corr ( {s}_{fiber 1} ( {𝔷}_{i} , {t}_{a} ) , {s}_{fiber 1} ( {𝔷}_{j} , {t}_{a} ) ) . \qquad ( 5 )$$

The similarity (Pearson correlation coefficient a_{i,j}) between the acoustic vibrations (i.e. the acoustic vibration signals) measured at different FUT locations [symbol] ᵢ and [symbol] ⱼ may be calculated. Referring to the concept of “co-trench detection”, if the Pearson correlation coefficient at, between the acoustic vibrations measured at different FUT locations [symbol] ᵢ and [symbol] ⱼ is large, it means that [symbol] ᵢ and [symbol] ⱼ have similar acoustic signature. And it may be considered that the spatial distance d_{i,j} for the fiber locations [symbol] ᵢ and [symbol] ⱼ is small. In other words, the Pearson correlation coefficient a_{i,j} between the acoustic vibrations measured at different FUT locations [symbol] ᵢ and [symbol] ⱼ depends on the spatial distance d_{i,j} of the different FUT locations [symbol] ᵢ and [symbol] ⱼ. For example, if these locations are spatially close, and assuming a broadband acoustic noise, then a_{i,j} will be high (closer to unit), and as the spatial distance d_{i,j} between [symbol] ᵢ and [symbol] ⱼ increases, a_{i,j} will decrease. Therefore, the spatial distance d_{i,j} of the different FUT locations [symbol] ᵢ and [symbol] ⱼ may be determined based on the Pearson correlation coefficient a_{i,j} between the acoustic vibrations measured at different FUT locations [symbol] ᵢ and [symbol] ⱼ.

A process in which the fiber shape measurement apparats may determine the fiber distance between each pair of fiber segments is described in detail below.

In some examples, the step 502 may include: determining the fiber distance based on a speed at which an optical signal propagates in the optical fiber, and a measured propagation time of the optical signal between segments in the pair of fiber segments.

In order to measure the specific shape of the FUT, the fiber distance Δ [symbol] _{i,j} between [symbol] ᵢ and [symbol] ⱼ may be obtained. There may be many well-established methods for the fiber distance Δ [symbol] _{i,j} between different FUT locations [symbol] ᵢ and [symbol] ⱼ. For example, the fiber distance Δ [symbol] _{i,j} between different FUT locations [symbol] ᵢ and [symbol] ⱼ may be calculated based on the speed of an optical signal c at which the optical signal propagates through the optical fiber, and the time required for the optical signal to propagate between [symbol] ᵢ and [symbol] ⱼ. The speed c may be determined by a time the optical signal travels through the fiber and a length of the fiber. In order to measure the fiber distance Δ [symbol] _{i,j}, an optical signal may be used to propagate from [symbol] ᵢ to [symbol] ⱼ and back to [symbol] ᵢ. The start time may be represented as τⱼ and the end time may be represented as τᵢ. Because the optical signal may propagate the fiber distance Δ [symbol] _{i,j} twice, then the fiber distance Δ [symbol] _{i,j} between different FUT locations [symbol] ᵢ and [symbol] ⱼ may be obtained from:

$$Δ {𝔷}_{i , j} = c ( {τ}_{i} - {τ}_{j} ) / 2. \qquad ( 6 )$$

The fiber distance Δ [symbol] _{i,j} between different FUT locations [symbol] ᵢ and [symbol] ⱼ and the spatial distance d_{i,j} between different FUT locations [symbol] ᵢ and [symbol] ⱼ may be combined, thus achieving the measurement of the FUT shape.

A process in which the fiber shape measurement apparatus may determine the shape of the optical fiber based on the spatial distance and the fiber distance of each pair of fiber segments in the plurality of fiber segments is described in detail below.

In some examples, the step 503 may include: determining a first acoustic correlation map based on the spatial distances and the fiber distances, where the first acoustic correlation map displays a relationship between the spatial distances and the fiber distances; and determining the shape of the optical fiber based on the first acoustic correlation map. For example, the first acoustic correlation map may be obtained by measuring the acoustic vibration signals for all fiber segments, and then calculating all elements of the auto-correlation matrix A as stated in Eq. (5). Because the spatial distances are inversely proportional to the similarity (correlation coefficient), the first acoustic correlation map may be obtained by inverting the auto-correlation matrix A, i.e., A⁻¹. Using a plurality of simulated fiber shapes and their corresponding simulated acoustic correlation maps to train a neural network, it is possible to achieve a trained neural network capable of admitting an acoustic correlation map as an input, and providing an output which may be the fiber shape. Thus, the fiber shape may be obtained as the output of the trained neural network when using the measured acoustic correlation map as the input.

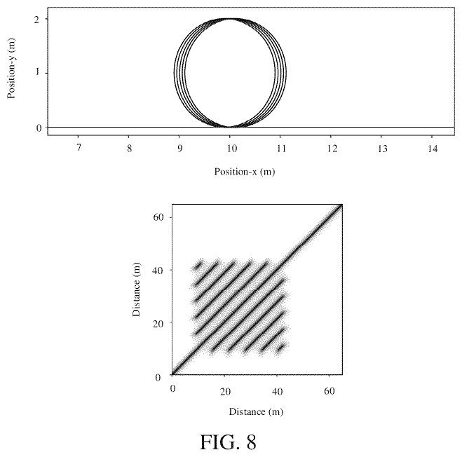

The above FUT shape measurement method is illustrated below using FIG. 7 as an example.

The locations [symbol] ᵢ and [symbol] ⱼ in FIG. 7 are selected after segmenting the FUT. For example, the FUT of length L₁ is uniformly divided into 50 segments, and two positions from different segments are taken as an example. So i∈[0,50], j∈[0,50], [symbol] ᵢ∈[0, L₁] and [symbol] ⱼ∈[0, L₁]. The actual spatial distance between locations [symbol] ᵢ and [symbol] ⱼ may be expressed by:

$${d}_{i , j} = \sqrt{{( {x}_{i} - {x}_{j} )}^{2} + {( {y}_{i} - {y}_{j} )}^{2} + {( {z}_{i} - {z}_{j} )}^{2}} . \qquad ( 7 )$$

In Eq. (7), (xᵢ, yᵢ, zᵢ) and (xⱼ, yⱼ, zⱼ) are the spatial coordinates in the three-dimensional space where zᵢ and zⱼ are located. The distinction between [symbol] ᵢ and [symbol] ⱼ is made clear in FIG. 7, which shows an example of fiber deployed shape in a coordinate system with three dimensions.

The spatial coordinates in the three-dimensional space (xᵢ, yᵢ, zᵢ) and (xⱼ, yⱼ, zⱼ) are unable to be obtained from current technology. However, because the Pearson correlation coefficient a_{i,j} of the different FUT locations [symbol] ᵢ and [symbol] ⱼ depends on the spatial distance d_{i,j}, it may be determined based on the acoustic vibrations measured at [symbol] ᵢ and [symbol] ⱼ, allowing the reconstruction of the fiber's shape in the three-dimensional space.

In this way, the measured acoustic vibration signals s_{fiber1} ( [symbol] ᵢ, tₐ) and s_{fiber1} ( [symbol] ⱼ, tₐ) have high correlation, which means that the spatial distance d_{i,j} is very small, as shown in FIG. 7.

The fiber distance Δ [symbol] _{i,j} between the arbitrary FUT locations [symbol] ᵢ and [symbol] ⱼ may be calculated based on the speed of light c at which light propagates through the fiber, and the time t required for light to propagate between the FUT locations [symbol] ᵢ and [symbol] ⱼ. And the fiber distance Δ [symbol] _{i,j} between the different FUT locations [symbol] ᵢ and [symbol] ⱼ may be calculated from Eq. (6). Note that the fiber distance Δ [symbol] _{i,j} between the different FUT locations [symbol] ᵢ and [symbol] ⱼ may be very large depending on the number of loops (2×2πr in FIG. 7). From this concept, it is possible to measure the FUT shape based on the features present in the auto-correlation matrix A (which is henceforth referred as the correlation map).

In a possible implementation, by simulating a DAS system in the presence of random acoustic noise along the fiber for a plurality of shapes of optical fibers, then a plurality of corresponding acoustic correlation maps may be generated. By selecting a second acoustic correlation map from the plurality of the acoustic correlation maps simulated which is most similar to the first acoustic correlation map, the shape of the optical fiber may be determined as a shape of an optical fiber of the second acoustic correlation map.

The fiber shape measurement apparatus may obtain by simulation a database including a plurality of acoustic correlation maps and their corresponding fiber shapes. Simulations may start from any chosen fiber shape. For example, FIG. 8 shows a circular fiber shape with 5 loops (top) and its corresponding correlation map (bottom). The one shown in FIG. 8 (top panel) is composed of: a long straight path, followed by a wounded fiber length with 5 loops and a diameter of 2 meters, and ending with another straight path. The Rayleigh backscattering signal detected for a given fiber can be simulated using theoretical models such as the one described in “Φ-OTDR model for arbitrary laser linewidth and pulse duration based on fiber frozen-in stress” Pedro Tovar; et al. (2024), which is expressly incorporated by reference herein. To simulate the Rayleigh backscattering waterfall plot captured when probing a specific fiber shape, theoretical models may be modified to include acoustic noise in such a way that a pair of fiber segments spatially close experience similar acoustic noise, while the similarity drops when the distance between fiber segments increases. From a simulated waterfall plot, its corresponding acoustic map can be calculated by using Eq. (5), as shown in the bottom panel of FIG. 8. This process constitutes the generation of one pair of fiber shape and correlation map. The process may be repeated a number of times to generate a database composed of many pairs of the form {fiber shape; correlation map}. In a case where a first acoustic correlation map is obtained experimentally, a second acoustic correlation map may be determined from the database as the most similar to the first acoustic correlation map, and the fiber shape may be determined as the fiber shape of the second acoustic correlation map.

In case the second acoustic correlation map is significantly different from the first acoustic correlation map, then new pairs of the form {fiber shape; correlation map} may be generated and added to the database, aiming to simulate features present in the first acoustic correlation map. Then a new second acoustic correlation map is chosen from the updated database. This process may be repeated until the second correlation map presents features similar to those present in the first acoustic correlation map.

In this way, the fiber shape measurement apparatus may quickly find the most matching optical fiber shape in the database, which may be conducive to improving the efficiency of fiber shape measurement.

In another possible implementation, the fiber shape measurement apparatus may obtain the shape of the optical fiber by a trained neural network using the first acoustic correlation map, where the neural network is obtained by training sample data. The sample data may be generated by simulating a DAS system in the presence of random acoustic noise for a plurality of fiber shapes; in this case, a number of pairs of fiber shapes and their corresponding acoustic correlation maps may be generated, composing the sample data. The neural network may be trained using the acoustic correlation maps in the sample data as input, and the corresponding fiber shapes as the ground true output. Once the training process is completed, the first acoustic correlation map may be used as a new input to the neural network, which may provide as an output the fiber shape of the first acoustic correlation map.

The neural network model of the embodiments of this present disclosure may be trained by the fiber shape measurement apparatus or may be trained by another apparatus (e.g. a server). In one possible implementation, the fiber shape measurement apparatus may determine a first acoustic correlation map based on the spatial distances and the fiber distances, and then input the first acoustic correlation map into this neural network model, which may obtain the shape of the optical fiber.

By combining with the neural network technology, the method may further improve the speed and accuracy of the fiber shape measurement. In addition, the fiber shape measurement based on the neural network model may automatically learn shape features and make judgments in a data-driven manner. This may not only reduce a need for human intervention, but also reduce human error and improve an automation of the measurement process.

Embodiments of this disclosure use one distributed acoustic sensing (DAS) detection signal from a unique SC-SMF to measure a shape of the optical fiber. As the same acoustic noise is perceived for fiber segments spatially close, their high correlation indicates the proximity of fiber segments, which enables fiber shape measurement. Specifically, the correlation of acoustic noise between different locations in a single-core fiber may be obtained by one DAS system, so as to obtain the spatial distances between different fiber locations. Further, based on the measurement of spatial distances between different fiber locations, the shape of the fiber may be obtained by direct analysis of the correlation map.

Aspects of the present disclosure relate to means for fiber shape measurement in single-core fibers, which is able to differentiate locations where the fiber follows a straight path from those where it is deployed in loops (slacks). In addition, fiber shape sensing in SC-SMF is able to identify frauds in the deployed fiber length: the shortest distance between two optical network stations may be much smaller than the actual fiber deployed, because it may be composed of many fiber loops that may significantly increase the total deployed length. Because the link cost increases with fiber length, if more fiber than required is sold (within a margin of error), it constitutes a fraud. With the present disclosure, the number and length of fiber slacks in the link may be measured, thus preventing fraud in fiber links transactions.

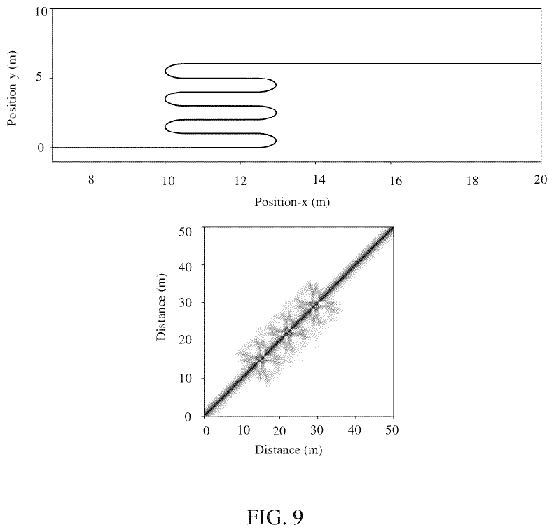

In summary, different shapes of optical fibers may correspond to different acoustic correlation maps. Embodiments of the present disclosure may provide a glossary of examples of fiber shapes and their corresponding correlation maps. Similar to the FIG. 8, FIGS. 9 to 11 present first the fiber shape (top panel) and then the corresponding correlation map (bottom panel).

Referring to the FIG. 8 again, according to the correlation map (bottom) shown in FIG. 8, there is a total of 11 diagonal lines which are symmetrically distributed around the longest line in the middle, which represents the correlation of every location with itself, thus always resulting in a strong correlation (a_{i,i}=1). Because a_{i,j}=a_{j,i}, i.e., because A is symmetric, there may be actually 5 unique lines in the correlation map, representing a total of 5 loops.

FIG. 9 shows a zigzag fiber shape (top) and its corresponding correlation map (bottom). In other words, FIG. 9 shows another possible case of fiber twisting and its simulation results.

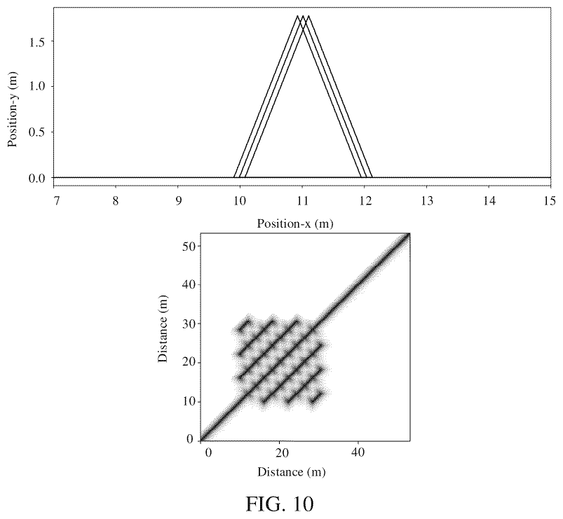

FIG. 10 shows a triangular fiber shape with 3 loops (top) and its corresponding correlation map (bottom). In other words, FIG. 10 shows another possible case of fiber twisting and its simulation results.

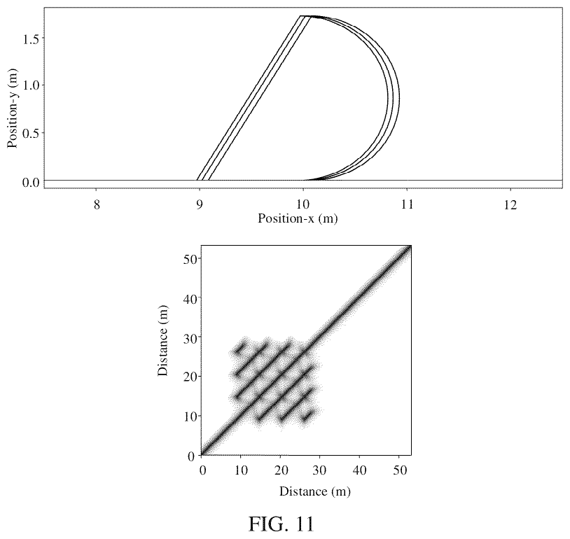

FIG. 11 shows half-triangular half-circular fiber shape with 3 loops (top) and its corresponding correlation map (bottom). In other words, FIG. 11 shows another possible case of fiber twisting and its simulation results.

From the distinct features of correlation maps, it is possible either through computer vision techniques or machine learning approaches to reconstruct the fiber shape for a given correlation map.

In the embodiments of present disclosure, it is the unique technique available for remote slack detection in single-core fibers. No other prior art is capable of doing so.

Although embodiments of the present disclosure may refer to telecom industry, the application's reach may go far beyond that. For instance, once the fiber shape is fully reconstructed, it may actually be used for trilateration to figure out the spatial coordinate of the acoustic source. This may find application in fiber to-the-room (FTTR), where the fiber in the room may act as a microphone array with known shape such that a person's fall, with a strong acoustic vibration coming from the ground, may be measured.

Another significant advantage of embodiments of the present disclosure is the improvement of the signal-to-noise ratio (SNR) of DAS systems. Since embodiments of the present disclosure are capable of identifying fiber loops, the acoustic signal measured by distant fiber points (the fiber distance Δ [symbol] _{i,j} is large) but spatially close (the spatial distance d_{i,j} is small) may be averaged, thereby increasing the SNR of DAS systems.

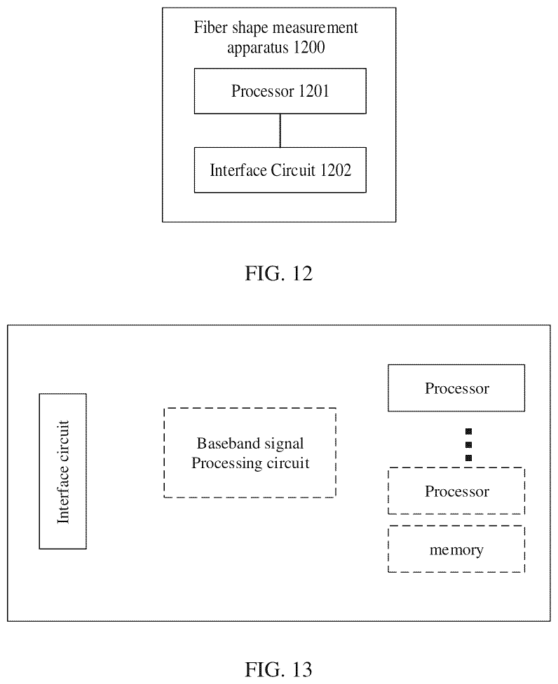

The fiber shape measurement method according to the embodiments of the present disclosure are described in detail above with reference to FIGS. 1 to 11. Next, the fiber shape measurement apparatus in the embodiments of the present disclosure will be described in detail below with reference to FIGS. 12 to 14.

In some embodiments of this disclosure, a fiber shape measurement apparatus (such as a module, modem, or chip) is also provided. The fiber shape measurement apparatus includes a processor and an interface circuit. The processor is connected to the interface circuit. The processor is configured to execute one or more instructions, and the interface circuit is configured to communicate with other network elements under the control of the processor. The processor is configured to: utilize other devices (e.g. AOM, AWG, EDFA, OC, BPD and DAQ shown in FIG. 1) to perform the fiber shape measurement method described above.

FIG. 12 illustrates a fiber shape measurement apparatus 1200 in accordance with some embodiments. As shown in FIG. 12, the fiber shape measurement apparatus includes a processor 1201 and an interface circuit 1202. The processor 1201 is connected to the interface circuit 1202. The processor 1201 is configured to perform any of the methods described above, and the interface circuit 1202 is configured to communicate with other devices under the control of the processor 1201. In some examples, the interface circuit 1202 may be configured to communicate with another component. For example, the interface circuit 1202 may communicate a signal with other apparatus/system such as a frequency processing apparatus, or processor system.

In some embodiments, the processor 1201 is configured to: determine, based on a correlation between measured acoustic vibration signals at segments in each pair of fiber segments in a plurality of fiber segments of an optical fiber, a spatial distance between each pair of fiber segments; determine a fiber distance between each pair of fiber segments of the plurality of fiber segments, where the fiber distance represents a path length along the optical fiber; and determine a shape of the optical fiber based on spatial distances and fiber distances of pairs of fiber segments in the plurality of fiber segments.

In some embodiments, the processor 1201 is further configured to: obtain the acoustic vibration signals by using a distributed acoustic sensing (DAS) system; calculate a similarity between the acoustic vibration signals at the segments in the pair of fiber segments, the similarity representing the correlation between the acoustic vibration signals at the segments in the pair of fiber segments; and determine the spatial distances based on similarities between acoustic vibration signals of segments in the pairs of fiber segments.

It is understood that the distributed acoustic sensing (DAS) system may be deployed within the fiber shape measurement apparatus or on other equipment, and that the fiber shape measurement apparatus may acquire acoustic vibration signals measured by the DAS system by sending measurement commands to the equipment in which the DAS system is deployed.

In some embodiments, the spatial distance is inversely proportional to the similarity.

In some embodiments, the processor 1201 is further configured to: determine the fiber distance based on a speed at which an optical signal propagates in the optical fiber, and a measured propagation time of the optical signal between segments in the pair of fiber segments.

In some embodiments, the processor 1201 is further configured to: determine a first acoustic correlation map based on the spatial distances and the fiber distances, where the first acoustic correlation map displays a relationship between the spatial distances and the fiber distances; and determine the shape of the optical fiber based on the first acoustic correlation map.

In some embodiments, the processor 1201 is further configured to: determine a plurality of shapes of optical fibers and a plurality of corresponding acoustic correlation maps by simulation; select a second acoustic correlation map from the plurality of the acoustic correlation maps simulated which is most similar to the first acoustic correlation map; and determine the shape of the optical fiber as a shape of an optical fiber of the second acoustic correlation map.

In some embodiments, the processor 1201 is further configured to: obtain the shape of the optical fiber by a trained neural network using the first acoustic correlation map, where the neural network is obtained by training sample data.

FIG. 13 illustrates an example apparatus in accordance with some embodiments of the present disclosure. The apparatus may be used to implement the method described above, and the apparatus may or may not include a DAS (e.g., AOM, AWG, EDFA, OC, BPD, and DAQ, etc.). For example, the apparatus may be an integrated circuit, which in some instances may be referred to as a chip, a modem, a modem chip, a baseband chip, or a baseband processor. In some implementations, one or more integrated circuits can be packaged into a system-on-chip, a system-in-package, or a multi-chip module. The apparatus can include one or more integrated circuits and other discrete components. In some implementations, the apparatus may be a module within an electronic device (ED), or within an apparatus.

In an example, the apparatus may include one or more processors, and an interface circuit. The apparatus may further include a memory. The one or more processors are configured to utilize other devices to perform the fiber shape measurement method described above. The memory is configured to store at least a part of corresponding computer program instructions and/or data. In an example, the one or more processors execute the computer program instructions stored in the memory to implement related operations (for example, inputting, outputting, receiving, and transmitting) in the method embodiments disclosed herein. In some implementations, the memory being configured to store the corresponding computer program instructions and/or data may mean that the memory is configured to store all of the corresponding computer program instructions and/or data for execution by the one or more processors. In some implementations, the memory being configured to store the corresponding computer program instructions and/or data may mean that the memory is configured to store a part of the corresponding computer program instructions and/or data. For example, the part of the corresponding computer program instructions and/or data may include computer program instructions and/or data that need to be currently executed by the one or more processors. Thus, the memory may store different parts of computer program instructions and/or data for a plurality of times for the one or more processors to perform related operations in the method embodiments disclosed herein. As a communication interface, the interface circuit is configured to implement communication with another component. For example, the interface circuit may communicate a signal with another apparatus or system, such as a radio frequency processing apparatus or another processor. The signal may include or carry information intended as a payload, such as user data, control information, etc. The signal may also include or carry information useful to a receiver, but not necessarily as a payload, such as a pilot signal or reference signal. Communicating the signal may include transmitting the signal to another component or device. Communicating the signal may additionally or alternatively include receiving the signal from another component or device. Transmitting the signal may include outputting the signal to a component or device that is directly or indirectly coupled to the interface circuit. Receiving the signal may include inputting or obtaining the signal from a component or device that is directly or indirectly coupled to the interface circuit. For example, to reduce a load of the one or more processors, a baseband signal processing circuit may be also disposed to implement processing of at least a part of baseband signals, including signal demodulation, modulation, encoding, decoding, or the like.

The apparatus may be a processor within an apparatus, in some scenarios, or may be included within the processor within the apparatus in some scenarios. The apparatus may be a baseband chip or may include a baseband chip. In some implementations, the apparatus may be independently packaged into a chip. In some implementations, the apparatus includes different types of chips. The apparatus may be packaged into a processor chip (for example, a system on chip (SoC) chip or a system in package (SIP) chip) with the different types of chips. In some implementations, the apparatus may be packaged into a chip with some or all of circuits of a radio frequency processing system that may further be included in the apparatus.

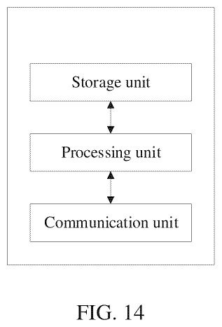

FIG. 14 illustrates example apparatus according to an implementation of the present disclosure. The apparatus may include corresponding modules or units configured to implement methods and/or implementations described herein. In some implementations, the apparatus includes a processing unit and a communication unit. For example, the apparatus may further include a storage unit configured to store apparatus program code (or instructions) and/or data.

In some implementations, when the apparatus is an ED or a module in an ED, a function of the apparatus may be implemented by one or more processors. Specifically, the processor may include a modem chip, or a system on chip (SoC) chip or an SIP chip that includes a modem core. A function of the communication unit may be implemented by a transceiver circuit.

In some implementations, when the apparatus is a circuit or a chip that is responsible for a communication function in an ED, such as a modem chip, a system on chip (SoC) chip or an SIP chip that includes a modem core-a function of the processing unit may be implemented by a circuit system within the chip which includes one or more processors. A function of the communication unit may be implemented by an interface circuit or a data transceiver circuit on the chip.

It may be understood that the units in the apparatus may be logical or functional. Each function may correspond to one functional unit, or two or more functions may be integrated into a single functional unit. In actual implementation, all or some of the units may be integrated into a single physical entity, or may be distributed across different physical entities. In addition, the functional units may be implemented in the form of hardware, software, or a combination of hardware and software. Whether a function is implemented in the form of hardware or software depends on particular applications and design constraint conditions of the technical solutions. A person skilled in the art may use different methods to implement the described functions for specific applications, but it should not be considered that the implementation goes beyond the scope of this disclosure.

In an example, a functional unit in any one of the apparatuses may be configured as one or more integrated circuits for implementing the methods disclosed herein, for example, as one or more application-specific integrated circuits (application-specific integrated circuits, ASICs), one or more central processing units (CPUs), one or more microprocessors or microprocessor units (MPUs), one or more microcontrollers or microcontroller units (MCUs), one or more digital signal processors (DSPs), one or more field programmable gate arrays (FPGAs), or a combination of these.

In an example, the storage unit may include a random access memory, a flash memory, a read-only memory, a programmable read-only memory, an electrically erasable programmable memory, and/or a register.

A processor may be referred to as a processor system, an application processor, a baseband processor, a processor circuit, or a processor core. The processor may include one or a combination of one or more central processing units (CPUs), one or more digital signal processors (DSPs), one or more microprocessors (microprocessor units, MPUs), one or more microcontrollers (microcontroller units, MCUs), one or more graphics processing units (GPUs), one or more field programmable gate arrays (FPGAs), one or more artificial intelligence processors (AI processors), or one or more neural network processing units (NPUs).

Memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM), a cache, a register, a read-only memory (ROM), a flash memory (flash memory), an erasable programmable read-only memory (erasable programmable ROM, EPROM), a hard disk, and the like. In an example, computer program instructions used to execute embodiments may be stored in a non-volatile memory, for example, at least a part of a memory or storage unit (for example, one or more of a ROM, a flash memory, an EPROM, or a hard disk). When a terminal runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the method embodiments disclosed herein.

In some embodiments of this disclosure, a computer-readable storage medium is provided. The computer-readable storage medium stores computer-readable instructions, and when a computer reads and executes the computer-readable instructions, the computer is enabled to utilize other devices to perform the fiber shape measurement method.

In some embodiments of this disclosure, a computer program product is provided. When a computer reads and executes the computer program product, the computer is enabled to utilize other devices to perform the fiber shape measurement method.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in different embodiments of this disclosure. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this disclosure are used to distinguish between a plurality of objects, and are not used to limit a sequence, a time sequence, priorities, or importance of the plurality of objects.

A person skilled in the art should understand that embodiments of this disclosure may be provided as a method, an apparatus (or system), computer-readable storage medium, or a computer program product. Therefore, this disclosure may use a form of a hardware-only embodiment, a software-only embodiment, or an embodiment with a combination of software and hardware. Moreover, this disclosure may use a form of a computer program product that is implemented on one or more computer-usable storage media (including but not limited to a disk memory, an optical memory, and the like) that include computer-usable program code.

This disclosure is described with reference to the flowcharts and/or block diagrams of the method, the device (system), and the computer program product according to this disclosure. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device and enable a machine to execute the instructions. When executed by any computer or the processor of a programmable data processing device, the instructions cause the apparatus to implement specific functions as described in one or more procedures in the flowcharts and/or one or more blocks in the block diagrams. The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or on another programmable device provide steps for implementing specific functions as described in one or more procedures in the flowcharts and/or one or more blocks in the block diagrams.

It is clear that a person skilled in the art can make various modifications and variations to this disclosure without departing from the scope of this disclosure. This disclosure is intended to cover these modifications and variations of this disclosure provided that they fall within the scope of protection defined by the following claims and their equivalent technologies.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although present disclosure refers to illustrative embodiments, this is not intended to be construed in a limiting sense. Various modifications and combinations of the illustrative embodiments, as well as other embodiments of present disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

1. A method for an optical fiber shape measurement, the method comprising:
determining, based on a correlation between measured acoustic vibration signals at segments in each pair of fiber segments in a plurality of fiber segments of an optical fiber, a spatial distance between each pair of fiber segments;
determining a fiber distance between each pair of fiber segments of the plurality of fiber segments, wherein the fiber distance represents a path length along the optical fiber; and
determining a shape of the optical fiber based on spatial distances and fiber distances of pairs of fiber segments in the plurality of fiber segments.

2. The method of claim 1, further comprising:
obtaining the acoustic vibration signals by using a distributed acoustic sensing (DAS) system;
calculating a similarity between the acoustic vibration signals at the segments in the pair of fiber segments, the similarity representing the correlation between the acoustic vibration signals at the segments in the pair of fiber segments; and
determining the spatial distances based on similarities between acoustic vibration signals of segments in the pairs of fiber segments.

3. The method of claim 2, wherein the spatial distance is inversely proportional to the similarity.

4. The method of claim 1, wherein determining the fiber distance comprises:
determining the fiber distance based on a speed at which an optical signal propagates in the optical fiber, and a measured propagation time of the optical signal between segments in the pair of fiber segments.

5. The method of claim 1, wherein determining the shape of the optical fiber comprises:
determining a first acoustic correlation map based on the spatial distances and the fiber distances, wherein the first acoustic correlation map displays a relationship between the spatial distances and the fiber distances; and
determining the shape of the optical fiber based on the first acoustic correlation map.

6. The method of claim 5, wherein determining the shape of the optical fiber comprises:
determining a plurality of shapes of optical fibers and a plurality of corresponding acoustic correlation maps by simulation;
selecting a second acoustic correlation map from the plurality of the acoustic correlation maps simulated which is most similar to the first acoustic correlation map; and
determining the shape of the optical fiber as a shape of an optical fiber of the second acoustic correlation map.

7. The method of claim 5, wherein determining the shape of the optical fiber comprises:
obtaining the shape of the optical fiber by a trained neural network using the first acoustic correlation map, wherein the neural network is obtained by training sample data.

8. An apparatus for an optical fiber shape measurement, the apparatus comprising:
a processor and an interface circuit, wherein the processor is connected to the interface circuit, and the processor is configured to:
determine, based on a correlation between measured acoustic vibration signals at segments in each pair of fiber segments in a plurality of fiber segments of an optical fiber, a spatial distance between each pair of fiber segments;
determine a fiber distance between each pair of fiber segments of the plurality of fiber segments, wherein the fiber distance represents a path length along the optical fiber; and
determine a shape of the optical fiber based on spatial distances and fiber distances of pairs of fiber segments in the plurality of fiber segments.

9. The apparatus of claim 8, wherein the processor is further configured to:
obtain the acoustic vibration signals by using a distributed acoustic sensing (DAS) system;
calculate a similarity between the acoustic vibration signals at the segments in the pair of fiber segments, the similarity representing the correlation between the acoustic vibration signals at the segments in the pair of fiber segments; and
determine the spatial distances based on similarities between acoustic vibration signals of segments in the pairs of fiber segments.

10. The apparatus of claim 9, wherein the spatial distance is inversely proportional to the similarity.

11. The apparatus of claim 8, wherein the processor is further configured to:
determine the fiber distance based on a speed at which an optical signal propagates in the optical fiber, and a measured propagation time of the optical signal between segments in the pair of fiber segments.

12. The apparatus of claim 8, wherein the processor is further configured to:
determine a first acoustic correlation map based on the spatial distances and the fiber distances, wherein the first acoustic correlation map displays a relationship between the spatial distances and the fiber distances; and
determine the shape of the optical fiber based on the first acoustic correlation map.

13. The apparatus of claim 8, wherein the processor is further configured to:
determine a plurality of shapes of optical fibers and a plurality of corresponding acoustic correlation maps by simulation;
select a second acoustic correlation map from the plurality of the acoustic correlation maps simulated which is most similar to the first acoustic correlation map; and
determine the shape of the optical fiber as a shape of an optical fiber of the second acoustic correlation map.

14. The apparatus of claim 8, wherein the processor is further configured to:
obtain the shape of the optical fiber by a trained neural network using the first acoustic correlation map, wherein the neural network is obtained by training sample data.

15. A computer-readable storage medium having instructions stored thereon which, when executed by one or more processors, cause the one or more processors to perform operations including:
determining, based on a correlation between measured acoustic vibration signals at segments in each pair of fiber segments in a plurality of fiber segments of an optical fiber, a spatial distance between each pair of fiber segments;
determining a fiber distance between each pair of fiber segments of the plurality of fiber segments, wherein the fiber distance represents a path length along the optical fiber; and
determining a shape of the optical fiber based on spatial distances and fiber distances of pairs of fiber segments in the plurality of fiber segments.

16. The computer-readable storage medium of claim 15, the operations further comprising:
obtaining the acoustic vibration signals by using a distributed acoustic sensing (DAS) system;
calculating a similarity between the acoustic vibration signals at the segments in the pair of fiber segments, the similarity representing the correlation between the acoustic vibration signals at the segments in the pair of fiber segments; and
determining the spatial distances based on similarities between acoustic vibration signals of segments in the pairs of fiber segments.

17. The computer-readable storage medium of claim 16, wherein the spatial distance is inversely proportional to the similarity.

18. The computer-readable storage medium of claim 15, wherein determining the fiber distance comprises:
determining the fiber distance based on a speed at which an optical signal propagates in the optical fiber, and a measured propagation time of the optical signal between segments in the pair of fiber segments.

19. The computer-readable storage medium of claim 15, wherein determining the shape of the optical fiber comprises:
determining a first acoustic correlation map based on the spatial distances and the fiber distances, wherein the first acoustic correlation map displays a relationship between the spatial distances and the fiber distances; and
determining the shape of the optical fiber based on the first acoustic correlation map.

20. The computer-readable storage medium of claim 19, wherein determining the shape of the optical fiber comprises:
determining a plurality of shapes of optical fibers and a plurality of corresponding acoustic correlation maps by simulation;
selecting a second acoustic correlation map from the plurality of the acoustic correlation maps simulated which is most similar to the first acoustic correlation map; and
determining the shape of the optical fiber as a shape of an optical fiber of the second acoustic correlation map.
